(19) United States
(12) Patent Application Publication
(10) Pub. No.: US 2024/0115042 A1
(43) Pub. Date: Apr. 11, 2024

(54) LOCKER-STYLE STORAGE CONTAINER AND A PARAPHERNALIA DISTRIBUTION KIT AND METHOD

(71) Applicant: Big Shot Merchandise and Apparel, LLC, Highland, UT (US)

(72) Inventor: Jordan Raymond Sitterud, Highland, UT (US)

(21) Appl. No.: 18/483,382

(22) Filed: Oct. 9, 2023

Related U.S. Application Data
(60) Provisional application No. 63/414,259, filed on Oct. 7, 2022.

(51) Int. Cl. A47B 67/04; G09F 23/00

(52) U.S. Cl. CPC A47B 67/04; G09F 23/00; G09F 2023/0025

(57) ABSTRACT

Disclosed is a locker-style storage container for increasing the interest of fans in sports teams, other organizations, or events related thereto. The storage container comprises a plurality of compartments formed from a plurality of panels and sidewalls. Optionally, a cover conceals the compartments to form the outside of the storage container.

### CROSS-REFERENCE TO RELATED APPLICATIONS

This application claims the benefit of and priority to U.S. Provisional Patent Application Ser. No. 63/414,259 filed Oct. 7, 2022 and entitled “Locker-style Storage Container,” which is expressly incorporated herein by reference. This application also claims the benefit of and priority to U.S. Design patent application Ser. Nos. 29/852,910 filed Sep. 10, 2022 and entitled “Locker-style Storage Container” and Ser. No. 29/855,890 filed Oct. 7, 2022 and entitled “Locker-style Storage Container”, which are also expressly incorporated herein by reference.

### TECHNICAL FIELD

This disclosure relates to product packaging, especially in regard to packaging of sports team paraphernalia. Sports teams have an important impact on their fans, or “adherents.” Adherents of sports teams generally have higher levels of self-esteem, report fewer episodes of loneliness, and report greater satisfaction with their lives. Connection with a sports team helps adherents develop pride, shared identity, and a sense of belonging. For many adherents, a sports team is an expression of one's very self. Maintaining an interest in sports teams can have very real implications for one's health and enjoyment.

Sports teams and their owners also benefit from increased interest and engagement from their adherents. Adherents with enduring interest buy more merchandise, go to more games, are more likely to share their enthusiasm with others, and do more to support their teams. Hence, sports team organizations often spend considerable effort to maintain the interest of their adherents in the team.

One obstacle for sports team organizations is that their adherents' interest may fade or wane over the course of a sports season. Interest may fade because the team fails to win as many games as the adherents expected, the team loses valuable players which diminishes the adherent's expectations of future games won, or from competition for that player's interest among multiple sports teams. Therefore, a need exists for products and methods for organizations that will maintain the interest of adherents in those organizations.

### SUMMARY

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

The present disclosure aims to increase adherents' interest and engagement with sports teams, organizations, or a series of events.

Disclosed is storage container comprising: a base including a back panel, a plurality of sidewalls, including a left sidewall, a top sidewall, a right sidewall, and a bottom sidewall, at least two sidewalls connected to the back panel, and a plurality of divider panels oriented transverse to the back panel, the divider panels and sidewalls forming compartments, each compartment having an opening opposite the back panel. The storage container may include a plurality of drawers. Each compartment may additionally include one or more items of sports paraphernalia or other items, the items of each compartment relating sequentially to a series of events. A cover may be connected to at least one sidewall, wherein the cover extends sufficient width and height to conceal the drawers and wherein the outside surface of the cover includes indicia of vents at the top and bottom of the cover and of a lock on the left side of the cover so that the storage container resembles a sports locker.

Further disclosed is a storage container to be delivered to the adherent. The storage container has the outward appearance of a locker and is used to hold items related to the team, organization, or series of events. The locker-like appearance is reminiscent of the lockers allocated to players in sports team locker-rooms and helps the adherent feel like a member of the team. Items associated with an event related to the team, organization, or series of events may be placed in the storage container before delivery to the adherent. The items help to build anticipation and excitement in the adherent for the event. The items may also help the adherent to feel invested in the event by possessing an item specifically related to the event. The adherent is thereby encouraged to use the item to engage with the event. The items also deter the adherent from forgetting or neglecting to engage with the event. If the adherent fails to use the item in the course of the event, the item may lose its primary usefulness which creates a sense of loss in the adherent, an outcome the adherent may seek to avoid.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1 is a perspective view of an exemplary embodiment of the storage container with the cover in an open position, with drawers placed within the compartments.

FIG. 2 is a perspective view of an exemplary embodiment of the storage container and illustrates a storage container whose drawer is partially extended.

FIG. 2A is a perspective view of an exemplary embodiment of a kit including a storage container according to the embodiment of FIG. 1 with a drawer is partially extended that contains paraphernalia or merchandise.

FIG. 3 illustrates an exemplary embodiment of a drawer.

FIG. 3A illustrates an exemplary embodiment of a drawer of the embodiment of FIG. 2A containing paraphernalia or merchandise.

FIG. 4 is a perspective view of an exemplary embodiment of a storage container having empty compartments.

FIG. 5 is a perspective view of an exemplary embodiment of a storage container with the cover secured to the base.

FIG. 6 is a front view of an exemplary embodiment of the base of the storage container with a view of empty compartments.

FIG. 7 is a front view of an exemplary embodiment of the base of the storage container, with drawers placed within the compartments.

FIG. 8 is a front view of an exemplary embodiment of the base of the storage container. The embodiment includes nine compartments, organized into three rows and three columns, drawers placed within the compartments.

FIG. 9 is a perspective view of another embodiment of a storage container with the cover in a closed position.

FIG. 10 is a perspective view of the embodiment of FIG. 9 with the cover in the open position and with a drawer fully extended.

FIG. 10A is a perspective view of an exemplary embodiment of a kit including a storage container according to the embodiment of FIG. 9 with a drawer is extended that contains paraphernalia or merchandise.

### DETAILED DESCRIPTION

Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

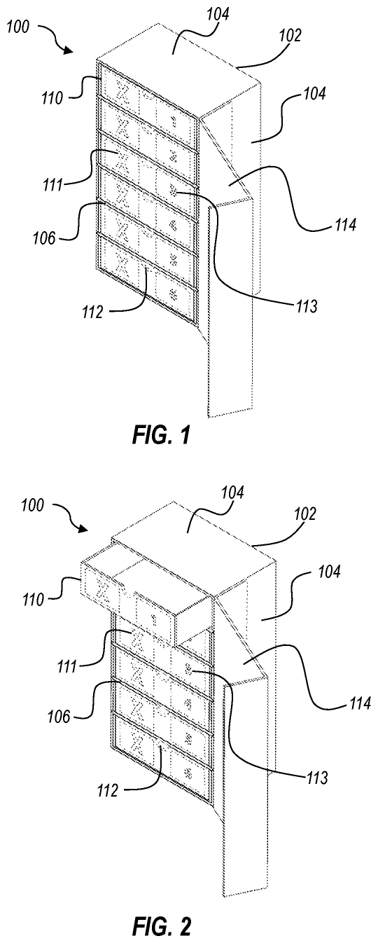

New storage containers and methods of constructing and filling storage containers are discussed herein. FIG. 1 depicts an exemplary embodiment of a storage container 100, shown in perspective view. An exemplary embodiment of a storage container is a locker-type storage container that includes a base 102 and a cover 114. The base 102 comprises a back panel, four sidewalls 104 (top, bottom, right, and left), as well as a plurality of divider panels 106, for example, five divider panels 106 forming six compartments 108. The number of divider panels 106 may be greater than five divider panels 106 to form more than six compartments 108, or the number of divider panels 106 may be less than five, to form less than six compartments 108. For example, the number of divider panels 106 may be 2, 3, 4, 6, 7, 8, 9, 10, 11, 12, or greater than 12, with a corresponding number of formed compartments. The height of the formed compartments 108 may be equal in height or may vary in height. The components of the base 102 as well as the cover may be made from one material or from a plurality of different materials. Additionally, each component could be composed of a material not used in any other component.

The compartments 108 are arranged or sized to contain paraphernalia, such as sporting event paraphernalia, for a series of upcoming sporting events, for example, for a number of sporting games of a sports season. As an example, a college football team may have 6 regular-season football home games scheduled for a season. The locker-container may thus be arranged as shown in FIG. 1, 2, or 4, with a compartment 108 corresponding to each home game. Of course, the number of games or events may vary. For example, a compartment may be provided for each game of a season for a football team, such as 12 total compartments 108. Or the number of compartments may correspond to a subset of games of a sporting team, such as games for a certain month. Or the number of compartments may correspond to a series within a season, such as a 3-game, 4-game, 5-game scheduled series of baseball games for the same baseball teams within a regular season or within a playoff series. Or the number of compartments may be numbered or arranged to correspond to a series of scheduled races on a race track, such as a NASCAR race track or motor sport race track.

The compartments 108 may be arranged or sized to contain paraphernalia of non-sporting events, such as a series of events within a conference, club, or itinerary. For example, the locker-container may be arranged with a compartment 108 corresponding to each panel within a professional or scientific conference or corresponding to each event or a subset of events at a comic con. Or the number of compartments may correspond to the number of books read in a book club over a predetermined portion of time. Or the number of compartments may correspond to the ports of call a cruise makes during a cruise itinerary.

Materials for constructing each component of the base 102 include paperboard (including cardboard, chipboard, and containerboard), fiber board, wood, plastic (such as polyvinyl chloride, polyethylene terephthalate, or polypropylene), or metal (such as aluminum, tin, or steel). In preferred embodiments, the materials used are sufficiently rigid to allow multiple storage containers to be stacked on top of each other.

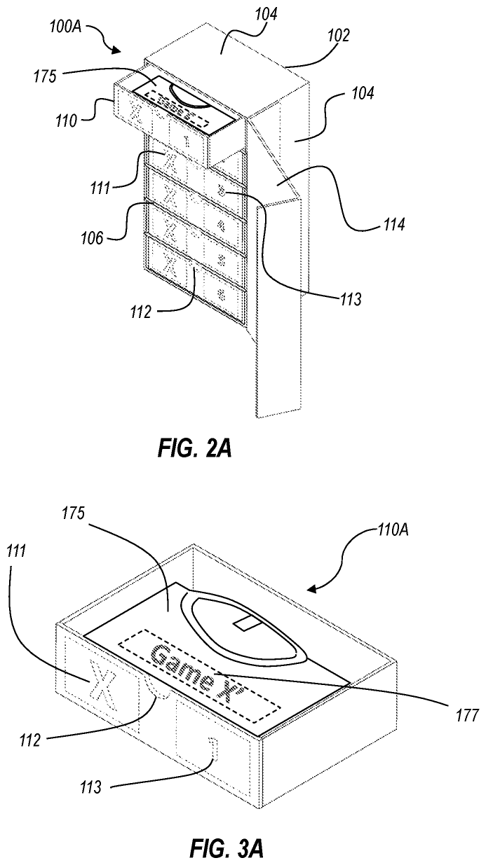

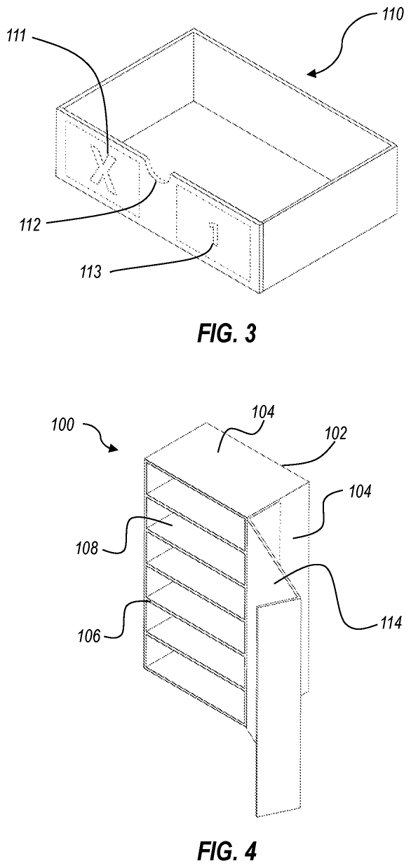

In some embodiments, drawers 110 may be placed in each of the compartments 108, such that the drawers 110 may slide in and out of the compartment 108, giving access to the compartment 108. FIG. 2 illustrates an exemplary embodiment wherein a drawer 110 is partially extended. The drawers 110 may optionally be configured with pull cutouts 112 to maneuver the drawer more easily. FIG. 3 displays an exemplary drawer 110 with the pull cutout 112. However, in other embodiments drawers 110 are omitted. FIG. 4 illustrates a storage container 100 without drawers 110. The compartments 108 may be left open or closed with a barrier. Barriers include flaps pivotally connected to the divider panels 106 or sidewalls 104 as well as paper strips fastened to the divider panels 106 or sidewalls 104 with an adhesive, staple, nail, screw, pin, or other fastener.

In preferred embodiments, compartment indicia associated with an event in relation to a team, organization, or series of events are placed on the front surface of the drawer 110 or barrier. Such compartment indicia may include the name, logo, or other identifying mark associated with a team or organization, the name, logo, or other identifying mark associated with a team or organization's opponent, or the date of the associated event. The compartment indicia may be placed on the drawers 110 or barriers in an order determined by a sequence of a series of events or part of a series of events.

For example, the storage container may include a left compartment indicia 111 and a right compartment indicia 113. The left compartment indicia 111 on all compartments may be identical so as to identify a single sports team. Specifically, the left compartment indicia 111 may identify a first university's football team, such as “BYU” or “University of Utah,” or the logos or other identifying mark of the university. The right compartment indicia 113 may alternatively correspond to a series of football games within the season of the university's football team. For example, the right compartment indicia 113 may identify opponent university football teams that play against the first university's football team, such as “Baylor,” “Notre Dame,” and “Oregon,” or the logos or other identifying mark of the opponent universities.

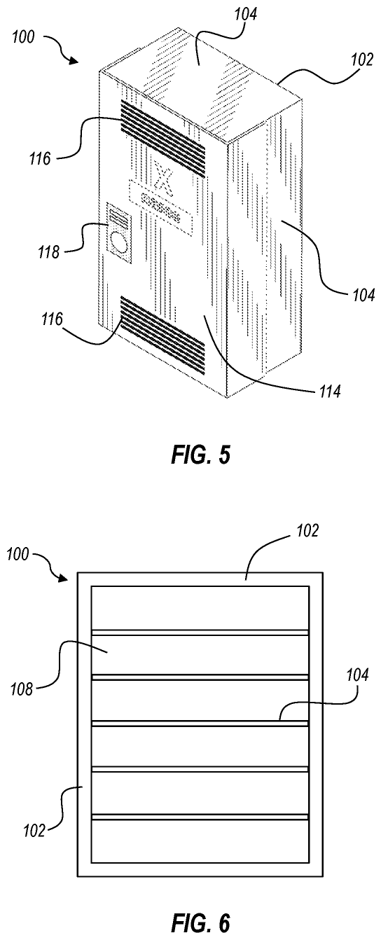

The storage container may optionally include a cover 114. In some embodiments the cover 114 is large enough to enclose all the drawers 110. FIG. 5 illustrates a storage container 100 with the cover 114 secured to the base 102. Generally, the cover 114 will be pivotally connected to at least one sidewall 104. The cover 114 may be pivotally connected to a sidewall 104 through a hinge, a spiral binding, a comb binding, one or more loops, zip ties, rope, string, or by a flap extending from the cover 114 fastened to a sidewall 104. The cover 114 may also be secured to another sidewall 104, allowing the storage container 100 to remain closed during handling. The cover 114 may be secured by a lock, a hook and loop fastener, a magnet, a pin, adhesive, a buckle, a zipper, string or rope, or a flap connected to the cover 114 and inserted into a slot in the base 102.

Indicia may be placed on the outside surface of the cover 114. Indicia may resemble elements of a sports locker and include indicia of vents 116, indicia of a lock 118, the adherent's name, as well as team names, logos, and phrases, and may include upcoming teams that will be played in the scheduled series of games. Alternatively, slats may be cut out of the cover 114 to make a vent 116.

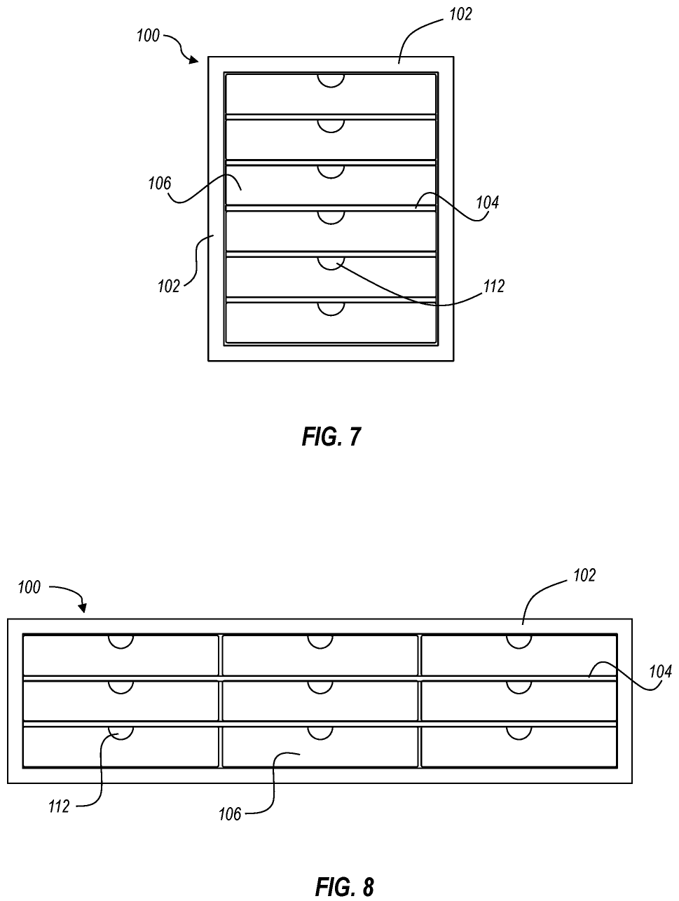

The base 102 may be configured to different dimensions. In some embodiments the base 102 has a greater height than its width while in other embodiments the base 102 has a greater width than its height. Additionally, the array of compartments 108 may take various arrangements. The compartments 108 may be arranged in one column, two columns, three columns, or more than three columns. The compartments 108 may also be arranged in one row, two rows, three rows, or more than three rows. FIGS. 6 and 7 illustrate the front view of a base 102 whose height is greater than its width and in which all the compartments 108 are arranged linearly in one column. Conversely, FIG. 8 illustrates a base 102 whose height is smaller than its width, resembling a footlocker. FIG. 8 also illustrates a storage container 100 whose compartments 108 are arranged in a grid of three rows of three columns.

FIG. 2A is a perspective view of an exemplary embodiment of a kit 100A including a storage container according to the embodiment of FIG. 1, with all reference numbers and features being similar, wherein each of the drawings include paraphernalia or merchandise, with a first of the drawings 110 is partially extended that contains paraphernalia or merchandise 175. FIG. 3A illustrates an exemplary embodiment of a drawer of the embodiment of FIG. 2A containing paraphernalia or merchandise 175. For each of the drawers or compartments, the paraphernalia or merchandise includes indicia or markings 177 corresponding with the indicia or markings 111 or 113, or both 111 or 113. For example, if the indicia or markings 111, 113 are for a game in the season, for example, game 1, where BYU plays Baylor, indicia or markings 177 paraphernalia or merchandise may say “Week 1—Go BYU, Beat Baylor” or something similar, or simply “Go BYU, Beat Baylor”, or any other team that is the opponent for that week or game corresponding to that drawer or compartment.

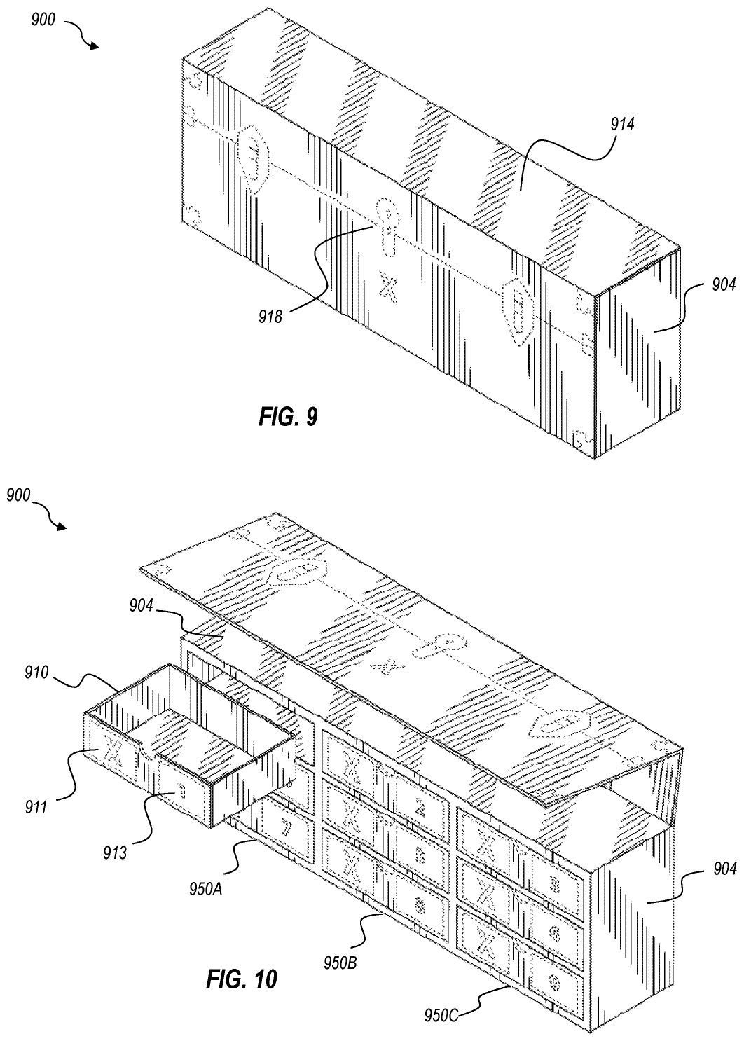

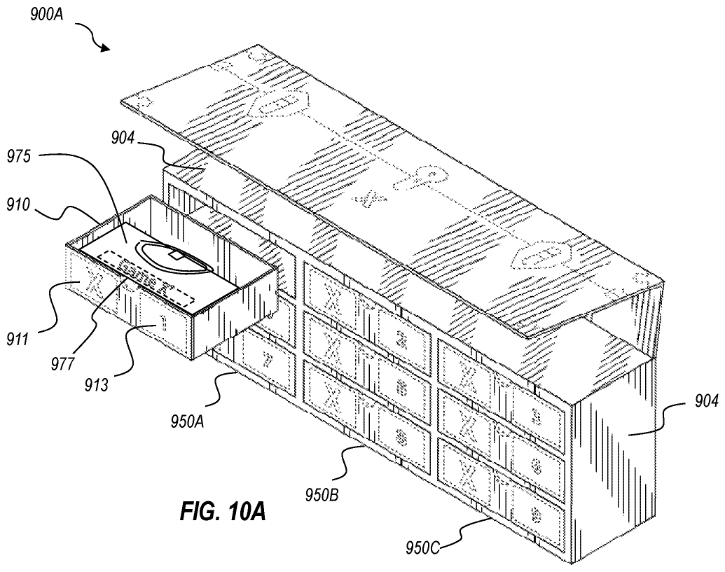

As shown in the example of FIGS. 9 and 10, the storage container is not limited to a single stack of drawings or compartments, but may include permutations or arrangements including two or more columns or drawers or compartments 950A, 950B, 950C . . . 950n, and one or more arrangements of rows. In the embodiment of FIGS. 9 and 10, the storage container 900 has cover 914, side walls 904, the drawers or compartments 910 may similarly have left compartment indicia 911 and a right compartment indicia 913. The left compartment indicia 911 on all compartments may be identical so as to identify a single sports team. Specifically, the left compartment indicia 911 may identify a first university's football team, such as “BYU” or “University of Utah,” or the logos or other identifying mark of the university. The right compartment indicia 913 may alternatively correspond to a series of football games within the season of the university's football team. For example, the right compartment indicia 913 may identify opponent university football teams that play against the first university's football team, such as “Baylor,” “Notre Dame,” and “Oregon,” or the logos or other identifying mark of the opponent universities.

Similarly, FIG. 10A is a perspective view of an exemplary embodiment of a kit 000A including a storage container according to the embodiment of FIGS. 9 and 10, with all reference numbers and features being similar, wherein each of the drawings include paraphernalia or merchandise, with a first of the drawings 910 is extended that contains paraphernalia or merchandise 975. For each of the drawers or compartments, the paraphernalia or merchandise includes indicia or markings 977 corresponding with the indicia or markings 911 or 913, or both 911 or 913. For example, if the indicia or markings 911, 913 are for a game in the season, for example, game 1, where BYU plays Baylor, indicia or markings 977 paraphernalia or merchandise may say “Week 1—Go BYU, Beat Baylor” or something similar, or simply “Go BYU, Beat Baylor”, or any other team that is the opponent for that week or game corresponding to that drawer or compartment.

In preferred embodiments, items associated with an event related to a team, organization, or series of events are placed in the compartments 108 before delivery to the adherent. The items may be placed in the compartments 108 in an order determined by a sequence of a series of events or part of a series of events. The items include sports paraphernalia, such as shirts, jerseys, pants, socks, shoes, hats, sweaters, jackets, coats, blankets, scarves, foam hands, sunglasses, pins, patches, sports equipment (including balls, gloves, and helmets as well as miniature sports equipment such as mini baseball bats and mini helmets), flags, posters, noise makers (including whistles, megaphones, clappers, thundersticks, cowbells, and air horns), bobbleheads, head bands, arm bands, jewelry (including rings, necklaces, and earrings), lanyards, stickers, decals, face paint, photos, cards, and coins.

This disclosure provides various examples, embodiments, features, and methods of a storage container, which improves and better maintains interest of the consumer for a period of time, for example, a sports season. Unless expressly stated, or unless such examples, embodiments, and features would be mutually exclusive, the various examples, embodiments, features, and methods disclosed herein should be understood to be combinable with other examples, embodiments, features, or methods described herein.

In addition to the above, further embodiments and examples include the following enumerated embodiments and methods.

1. A locker-type storage container comprising: a base that includes a back panel, a plurality of sidewalls, including a left sidewall, a top sidewall, a right sidewall, and a bottom sidewall, the sidewalls connected to the back panel, a plurality of divider panels oriented transverse to the back panel forming a series of compartments arranged linearly, and a plurality of drawers wherein each compartment holds one drawer and wherein each compartment and drawer contains one or more items of sports paraphernalia, the items of each drawer relating sequentially to a series of events; a cover connected to at least one sidewall, wherein the cover extends sufficient width and height to conceal the drawers and wherein the outside surface of the cover includes indicia of vents at the top and bottom of the cover and of a lock on the left side of the cover.

2. A storage container comprising: a base including a back panel, a plurality of sidewalls, including a left sidewall, a top sidewall, a right sidewall, and a bottom sidewall, at least two sidewalls connected to the back panel, and a plurality of divider panels oriented transverse to the back panel, the divider panels and sidewalls forming compartments, each compartment having an opening opposite the back panel.

The storage container of 2, wherein the base is taller than it is wide.

The storage container of 2, wherein the base is wider than it is tall.

The storage container of 2, wherein the plurality of divider panels are oriented perpendicular to the back panel.

The storage container of 2, wherein the compartments are arranged into one vertical column.

The storage container of 2, wherein the compartments are arranged into two vertical columns.

The storage container of 2, wherein the compartments are arranged into three vertical columns.

The storage container of 2, wherein the compartments are arranged into one horizontal row.

The storage container of 2, wherein the compartments are arranged into two horizontal rows.

The storage container of 2, wherein the compartments are arranged into three horizontal rows.

The storage container of 2, including a cover connected to at least one side wall.

The storage container of 12, wherein the cover is connected to the left sidewall.

The storage container of 12, wherein the cover is connected to the right sidewall.

The storage container of 12, wherein the cover is connected to the top sidewall.

The storage container of 12, wherein the cover is connected to the bottom sidewall.

The storage container of 12, wherein indicia resembling a lock is placed on the cover.

The storage container of 12, wherein indicia resembling a vent is placed on the cover.

The storage container of 12, wherein slats resembling a vent are cut out of the cover.

The storage container of 12, wherein the cover is additionally secured to the base using a fastener.

The storage container of 20, wherein the fastener is a lock

The storage container of 20, wherein the fastener is a hook and loop fastener.

The storage container of 20, wherein the fastener is a magnet.

The storage container of 20, wherein the fastener is a pin.

The storage container of 20, wherein the fastener is an adhesive.

The storage container of 20, wherein the fastener is a buckle.

The storage container of 20, wherein the fastener is a zipper.

The storage container of 20, wherein the fastener is a flap connected to the cover and inserted into a slot in the base.

The storage container of 20, wherein the cover is secured using rope, string, or other threaded material.

The storage container of 2, wherein items associated with a series of events are placed in one or more compartments.

The storage container of 30, wherein the items are sports paraphernalia.

The storage container of 2, wherein a drawer is placed in at least one or more compartments.

The storage container of 32, wherein a cutout is made on the front face of the drawer sufficiently wide to fit a person's finger.

The storage container of 32, wherein the front face of one or more drawers includes indicia of a date associated with a series of events.

The storage container of 32, wherein the front face of one or more drawers includes indicia of an event within a series of events.

The storage container of 32, wherein the front face of one or more drawers includes indicia of a selection of events within a series of events.

The storage container of 32, wherein the front face of one or more drawers includes indicia of one or more sports teams.

The storage container of 2, wherein one or more compartments are closed by a barrier.

The storage container of 38, wherein the barrier is a flap connected to a divider panel.

The storage container of 38, wherein the barrier is a strip of paper.

The storage container of 38, wherein a cutout is made on the front face of the barrier sufficiently wide to fit a person's finger.

The storage container of 38, wherein the front face of one or more barriers includes indicia of a date associated with a series of events.

The storage container of 38, wherein the front face of one or more barriers includes indicia of an event within a series of events.

The storage container of 38, wherein the front face of one or more barriers includes indicia of a selection of events within a series of events.

The storage container of 38, wherein the front face of one or more barriers includes indicia of one or more sports teams.

A kit for delivering sports paraphernalia comprising: the storage container of claim 1, and sports paraphernalia placed in one or more compartments of the storage container, each of the paraphernalia corresponding with the indicia of the drawing or compartment that contains the respective paraphernalia.

A method comprising: providing paraphernalia in one or more compartments of a storage container, and

providing the storage container including the paraphernalia included therein.

Certain terms are used throughout the description and claims to refer to particular methods, features, or components. As those having ordinary skill in the art will appreciate, different persons may refer to the same methods, features, or components by different names. This disclosure does not intend to distinguish between methods, features, or components that differ in name but not function. The figures are not necessarily drawn to scale. Certain features and components herein may be shown in exaggerated scale or in somewhat schematic form and some details of conventional elements may not be shown or described in interest of clarity and conciseness.

Although various example embodiments have been described in detail herein, those skilled in the art will readily appreciate in view of the present disclosure that many modifications are possible in the example embodiments without materially departing from the concepts of present disclosure. Accordingly, any such modifications are intended to be included in the scope of this disclosure. Likewise, while the disclosure herein contains many specifics, these specifics should not be construed as limiting the scope of the disclosure or of any of the appended claims, but merely as providing information pertinent to one or more specific embodiments that may fall within the scope of the disclosure and the appended claims. Any described features from the various embodiments disclosed may be employed in combination. In addition, other embodiments of the present disclosure may also be devised which lie within the scopes of the disclosure and the appended claims. Each addition, deletion, and modification to the embodiments that falls within the meaning and scope of the claims is to be embraced by the claims.

Certain embodiments and features may have been described using a set of numerical upper limits and a set of numerical lower limits. It should be appreciated that ranges including the combination of any two values, e.g., the combination of any lower value with any upper value, the combination of any two lower values, and/or the combination of any two upper values are contemplated unless otherwise indicated. Certain lower limits, upper limits and ranges may appear in one or more claims below. Any numerical value is “about” or “approximately” the indicated value, and takes into account experimental error and variations that would be expected by a person having ordinary skill in the art.

1. A storage container comprising:
a base that includes
a back panel,
a plurality of sidewalls, including a left sidewall, a top sidewall, a right sidewall, and a bottom sidewall, the sidewalls connected to the back panel,
a plurality of divider panels oriented transverse to the back panel, the divider panels and sidewalls forming compartments, each compartment having an opening opposite the back panel, and being configured to container paraphernalia corresponding to a series of planned events.

2. The storage container of claim 1, further comprising a plurality of drawers wherein each compartment holds one drawer and wherein each compartment and drawer contains the one or more items of paraphernalia, the items of each drawer relating sequentially to a series of events.

3. The storage container of claim 1, further comprising a cover connected to at least one sidewall, wherein the cover extends sufficient width and height to conceal the drawers and wherein the outside surface of the cover includes indicia of vents at the top and bottom of the cover and of a lock on the left side of the cover.

4. The storage container of claim 2, wherein each drawer includes a unique indicia relating to an event of the series of events to which the drawer corresponds sequentially.

5. The storage container of claim 1, wherein each compartment includes a unique indicia relating to an event of the series of events to which the drawer corresponds sequentially.

6. The storage container of claim 3, wherein indicia resembling a vent is placed on the cover.

7. The storage container of claim 3, wherein slats resembling a vent are cut out of the cover.

8. The storage container of claim 3, wherein the cover is additionally secured to the base using a fastener.

9. The storage container of claim 2, wherein a cutout is made on the front face of each of the drawers that is sufficiently wide to fit a person's finger.

10. The storage container of claim 3, wherein the indicia include an indication of the week number and an indication of an opponent representing a competitor for that week.

11. A kit of sports paraphernalia comprising:
the storage container of claim 1, and
sports paraphernalia placed in one or more compartments of the storage container.

12. The kit of claim 11, further comprising a plurality of drawers wherein each compartment holds one drawer and wherein each compartment and drawer contains the one or more items of paraphernalia, the items of each drawer relating sequentially to a series of events.

13. The kit of claim 11, further comprising a cover connected to at least one sidewall, wherein the cover extends sufficient width and height to conceal the drawers and wherein the outside surface of the cover includes indicia of vents at the top and bottom of the cover and of a lock on the left side of the cover.

14. The kit of claim 12, wherein each drawer includes a unique indicia relating to an event of the series of events to which the drawer corresponds sequentially.

15. The kit of claim 11, wherein each compartment includes a unique indicia relating to an event of the series of events to which the drawer corresponds sequentially.

16. The kit of claim 13, wherein indicia resembling a vent is placed on the cover.

17. The kit of claim 13, wherein slats resembling a vent are cut out of the cover.

18. The kit of claim 13, wherein the cover is additionally secured to the base using a fastener.

19. The kit of claim 13, wherein the indicia include an indication of the week number and an indication of an opponent representing a competitor for that week.

20. A method comprising:
providing a storage container of claim 1,
providing sports paraphernalia in the one or more compartments of the storage container.
